(19) United States
(12) Patent Application Publication
(10) Pub. No.: US 2024/0354696 A1
(43) Pub. Date: Oct. 24, 2024

(54) System and Method of Managing Complexity in Scheduling

(71) Applicant: Blue Yonder Group, Inc., Scottsdale, AZ (US)

(72) Inventor: Timothy Reed Hayes, Ponte Vedra Beach, FL (US)

(21) Appl. No.: 18/517,755

(22) Filed: Nov. 22, 2023

Related U.S. Application Data
(60) Provisional application No. 63/462,667, filed on Apr. 28, 2023.
(60) Provisional application No. 63/461,458, filed on Apr. 24, 2023.

(51) Int. Cl. G06Q 10/087

(52) U.S. Cl. CPC G06Q 10/087

(57) ABSTRACT

A system and method are disclosed for layered scheduling. The method includes partitioning a scheduling problem into ordered subsets based on a prioritization scheme, applying a scheduling algorithm to optimize a first subset of the ordered subsets and freeze a corresponding schedule, determining whether there are any remaining subsets that have not been optimized, in response to determining that there are remaining subsets that have not been optimized, loading a next subset ordered according to the prioritization scheme, optimizing the loaded subset without disturbing the frozen schedule, and in response to determining that there are no remaining subsets to optimize, running a final pass of the scheduling algorithm to improve the global schedule metrics. The method further includes where the prioritization scheme is based on a relative priority of tasks to be performed, a value of finished goods that are to be produced or requirements regarding a use of resources.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 illustrates a supply chain network, in accordance with a first embodiment;

FIG. 2 illustrates the layered scheduling system, the archiving system, and the planning and execution system of FIG. 1 in greater detail, in accordance with an embodiment;

FIG. 3 illustrates a method for layered scheduling, in accordance with an embodiment;

FIG. 4 illustrates a method for solving a supply chain scheduling problem, in accordance with an embodiment; and

FIGS. 5A-5C illustrate a method of performing layered scheduling in a factory scheduling setting, in accordance with an embodiment.

### DETAILED DESCRIPTION

Aspects and applications of the invention presented herein are described below in the drawings and detailed description of the invention. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

As described below, embodiments of the following disclosure provide systems and methods of using a layered approach to scheduling problems, where groups of demands are grouped into sets and the groups are planned in a specified sequence. Embodiments may partition the total scheduling problem into smaller, less complex components, and solve these components in a stepwise fashion. Embodiments may employ a second set of tuning algorithms to fine-tune the solution after the layered scheduling approach is completed. Embodiments may be used in settings where subsets of demand are sequenced by priority, such as due date, customer priority, or a combination of other attributes. Embodiments may balance one subset at a time, starting with the highest priority demand subset, and then lock the plan before solving the next demand subset. Embodiments may utilize a final solve pass to refine the plan and improve overall schedule metrics.

Use of embodiments may reduce the total complexity of scheduling problems, which reduces solve times and improves solution quality. Among other things, use of embodiments enables layered scheduling to simplify large, complex scheduling problems addressed in scheduling applications. In addition, or as an alternative, use of embodiments may improve schedule quality for scheduling use cases with very complex scheduling problems.

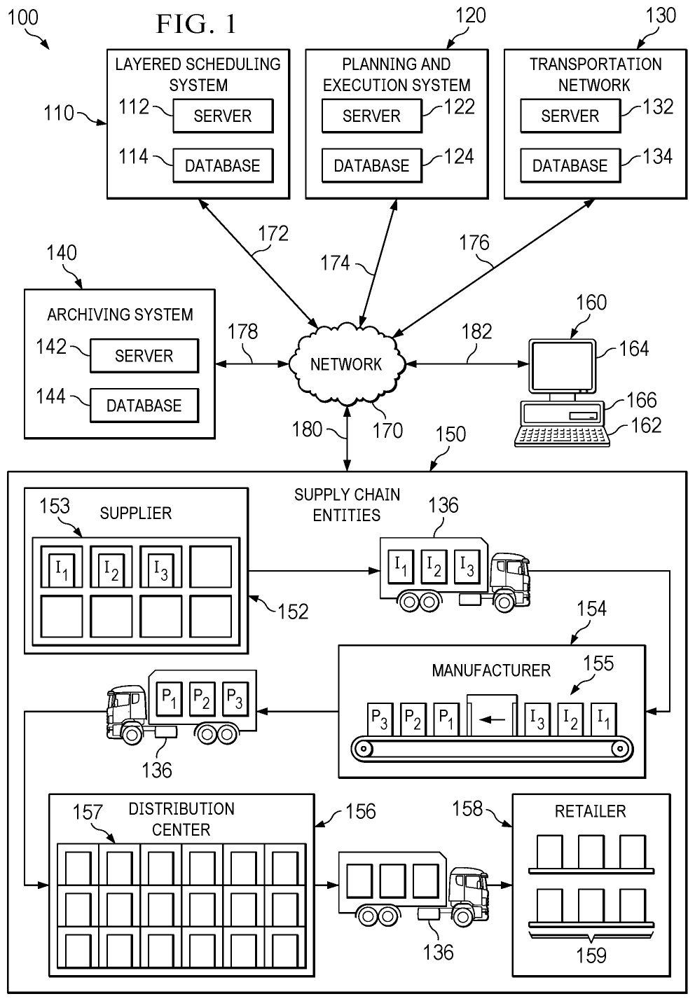

FIG. 1 illustrates supply chain network 100, in accordance with a first embodiment. Supply chain network 100 comprises layered scheduling system 110, planning and execution system 120, transportation network 130, archiving system 140, one or more supply chain entities 150, one or more computers 160, network 170, and communication links 172-182. Although a single layered scheduling system 110, a single planning and execution system 120, a single transportation network 130, a single archiving system 140, one or more supply chain entities 150, one or more computers 160, a single network 170, and one or more communication links 172-182 are shown and described, embodiments contemplate any number of layered scheduling systems, planning and execution systems, transportation networks, archiving systems, supply chain entities, computers, networks, or communication links, according to particular needs.

In one embodiment, layered scheduling system 110 comprises server 112 and database 114. Although layered scheduling system 110 is illustrated in FIG. 1 as comprising a single server 112 and a single database 114, embodiments contemplate layered scheduling system 110 including any suitable number of servers or databases, serverless computing options, or data stores, internal to, or externally coupled with, layered scheduling system 110, according to particular needs. For the purposes of this disclosure, all instances of “server” are understood to include, according to embodiments, one or more embodiments of servers, serverless computing options, and/or other computing solutions, and all instances of “database” are understood to include, according to embodiments, databases, datastores, data stores, and/or other data storage systems, according to particular needs. As explained in more detail below, layered scheduling system 110 applies layered scheduling to subdivide a scheduling problem, such as a factory scheduling problem, into ordered subsets. Layered scheduling system 110 may then solve the ordered subsets in a stepwise fashion to solve the scheduling problem while maintaining priority for resource demands, such as demands for resources in a production line. Although examples and embodiments provided herein use factories or manufacturers as example settings where layered scheduling may be applied to supply chain management, layered scheduling system 110 may solve scheduling problems for any entities 150 of supply chain network 100, such as one or more distribution centers 156, warehouses, logistics centers, transportation hubs, or any other supply chain entity.

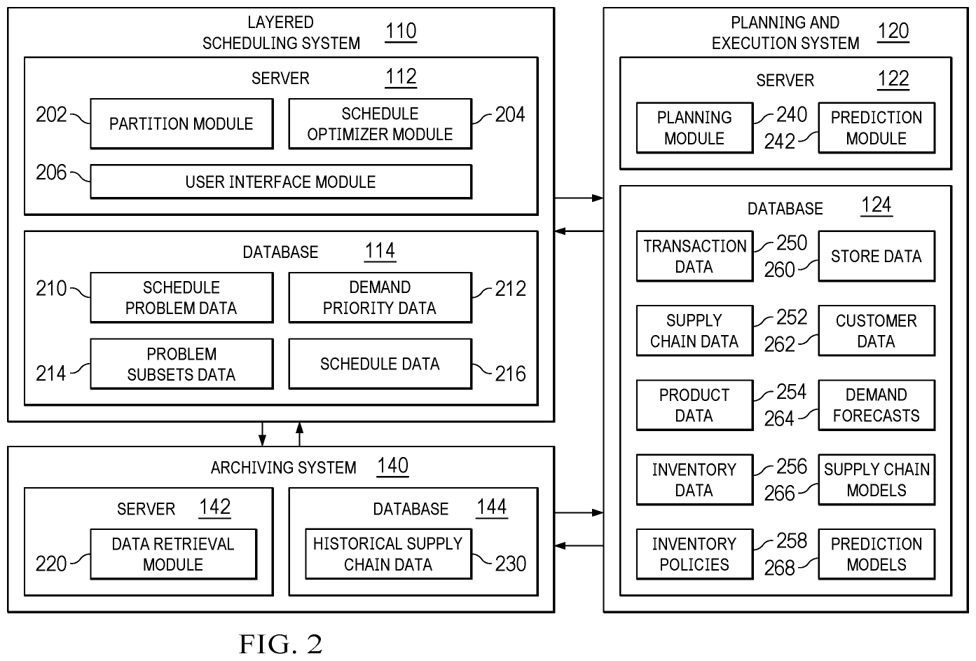

According to an embodiment, planning and execution system 120 comprises server 122 and database 124. Supply chain planning and execution is typically performed by several distinct and dissimilar processes, including, for example, assortment planning, demand planning, operations planning, production planning, supply planning, distribution planning, execution, pricing, forecasting, transportation management, warehouse management, inventory management, fulfilment, procurement, and the like. Server 122 of planning and execution system 120 comprises one or more modules, such as, for example, planning module 240 (FIG. 2), a solver, a modeler, and/or an engine, for performing actions of one or more planning and execution processes. Server 122 stores and retrieves data from database 124 or from one or more locations in supply chain network 100. In addition, planning and execution system 120 operates on one or more computers 160 that are integral to, or separate from, the hardware and/or software that support archiving system 140 and one or more supply chain entities 150. In an embodiment, server 122 of planning and execution system 120 is configured to receive and transmit item data, including item identifiers, pricing data, attribute data, inventory levels, and other like data about one or more items at one or more locations in supply chain network 100. Server 122 stores and retrieves item data from database 124 or one or more locations in supply chain network 100.

Transportation network 130 comprises server 132 and database 134. According to embodiments, transportation network 130 directs one or more transportation vehicles 136 to ship one or more items from one or more stocking locations of one or more supply chain entities 150. In embodiments, one or more transportation vehicles 136 may comprise a truck fleet used for performing deliveries. In addition, the number of items shipped by one or more transportation vehicles 136 in transportation network 130 may also be based, at least in part, on the number of items currently in stock at one or more stocking locations of one or more supply chain entities 150, the number of items currently in transit, a forecasted demand, a supply chain disruption, and the like. One or more transportation vehicles 136 comprise, for example, any number of trucks, cars, vans, boats, airplanes, unmanned aerial vehicles (UAVs), cranes, robotic machinery, or the like. According to embodiments, one or more transportation vehicles 136 may be associated with one or more supply chain entities 150 and may be directed by automated navigation including, for example, GPS guidance, according to particular needs.

Archiving system 140 of supply chain network 100 comprises server 142 and database 144. Although archiving system 140 is shown as comprising a single server 142 and a single database 144, embodiments contemplate any suitable number of servers or databases internal to, or externally coupled with, archiving system 140. Server 142 of archiving system 140 may support one or more processes for receiving and storing data from planning and execution system 120, one or more supply chain entities 150, and/or one or more computers 160 of supply chain network 100, as described in more detail herein. According to some embodiments, archiving system 140 comprises an archive of data received from planning and execution system 120, one or more supply chain entities 150, and/or one or more computers 160 of supply chain network 100. Archiving system 140 provides archived data to layered scheduling system 110 and/or planning and execution system 120 to, for example, train one or more machine learning models. Server 142 may store the received data in database 144. Database 144 of archiving system 140 may comprise one or more databases or other data storage arrangements at one or more locations, local to, or remote from, server 142.

One or more supply chain entities 150 may represent one or more suppliers 152, one or more manufacturers 154, one or more distribution centers 156, and one or more retailers 158 in one or more supply chain networks, including one or more enterprises. Each of one or more supply chain entities 150 may comprise Internet of things (IoT) sensors, which may automatically transmit conditions (e.g., location, temperature, etc.) of any object to layered scheduling system 110, planning and execution system 120, transportation network 130, and/or archiving system 140. The IoT sensors may transmit condition data periodically (e.g., every minute, every hour, every day, or the like), or may transmit condition data in response to a change (e.g., a door of a container being opened or closed).

One or more suppliers 152 may be any suitable entity that offers to sell or otherwise provides one or more items or components to one or more manufacturers 154. One or more suppliers may, for example, receive an item from a first supply chain entity of one or more supply chain entities 150 in supply chain network 100 and provide the item to another supply chain entity of one or more supply chain entities 150. Items may comprise, for example, components, materials, products, parts, supplies, or other items, that may be used to produce products. In addition, or as an alternative, an item may comprise a supply or resource that is used to manufacture the item but does not become a part of the item. One or more suppliers 152 may comprise automated distribution systems 153 that automatically transport items to one or more manufacturers 154 based, at least in part, on a supply chain plan, a material or capacity reallocation, current and projected inventory levels, and/or one or more additional factors described herein.

One or more manufacturers 154 may be any suitable entity that manufactures at least one item. One or more manufacturers 154 may use one or more items during the manufacturing process to produce any manufactured, fabricated, assembled, or otherwise processed item, material, component, good, or product. In one embodiment, a product represents an item ready to be supplied to, for example, another supply chain entity of one or more supply chain entities 150 such as one or more suppliers 152, an item that needs further processing, or any other item. One or more manufacturers 154 may, for example, produce and sell a product to one or more suppliers 152, another one or more manufacturers 154, one or more distribution centers 156, one or more retailers 158, a customer, or any other suitable entity. One or more manufacturers 154 may comprise automated robotic production machinery 155 that produce products based, at least in part, on a supply chain plan, a material or capacity reallocation, current and projected inventory levels, and/or one or more additional factors described herein.

One or more distribution centers 156 may be any suitable entity that offers to sell or otherwise distributes at least one product to one or more retailers 158 and/or customers. One or more distribution centers 156 may, for example, receive a product from a first supply chain entity of one or more supply chain entities 150 in supply chain network 100 and store and transport the product for a second supply chain entity of one or more supply chain entities 150. One or more distribution centers 156 may comprise automated warehousing systems 157 that automatically transport products to one or more retailers 158 or customers and/or automatically remove an item from, or place an item into, inventory, based, at least in part, on a supply chain plan, a material or capacity reallocation, current and projected inventory levels, and/or one or more additional factors described herein. One or more distribution centers 156 may utilize crossdocking to reduce product storage costs, when one or more distribution centers 156 are configured to support crossdocking.

One or more retailers 158 may be any suitable entity that obtains one or more products to sell to one or more customers. In addition, one or more retailers 158 may sell, store, and supply one or more components and/or repair a product with one or more components. One or more retailers 158 may comprise any online or brick and mortar location, including locations with shelving systems 159. Shelving systems 159 may comprise, for example, various racks, fixtures, brackets, notches, grooves, slots, or other attachment devices for fixing shelves in various configurations. These configurations may comprise shelving with adjustable lengths, heights, and other arrangements, which may be adjusted by an employee of one or more retailers 158 based on computer-generated instructions or automatically by machinery to place products in a desired location. In embodiments, one or more retailers 158 may comprise locations with data capture devices, such as IoT devices and cameras. IoT devices may include RFID sensors on shopping carts, RFID readers on aisles, and QR code or barcode scanners at drop boxes or other locations. Cameras may be located at aisles within the store, at entry and exit points of the retail location, at drop boxes, at checkout locations or any other location within one or more retailers 158. The data capture devices may be able to capture images of shoppers, emotions of shoppers, shopper gaze and fixation (based on eye tracking), time stamps or shopper activity, which products have been picked up or dropped by shoppers, among other types of shopper data.

Although one or more suppliers 152, one or more manufacturers 154, one or more distribution centers 156, and one or more retailers 158 are shown and described as separate and distinct entities, the same entity may simultaneously act as any other one or more suppliers 152, one or more manufacturers 154, one or more distribution centers 156, and one or more retailers 158. For example, one or more manufacturers 154 acting as a manufacturer may produce a product, and the same entity may act as one or more suppliers 152 to supply a product to another one or more supply chain entities 150. Although one example of supply chain network 100 is shown and described, embodiments contemplate any configuration of supply chain network 100, without departing from the scope of the present disclosure.

As shown in FIG. 1, supply chain network 100 comprising layered scheduling system 110, planning and execution system 120, transportation network 130, archiving system 140, and one or more supply chain entities 150 may operate on one or more computers 160 that are integral to or separate from the hardware and/or software that support layered scheduling system 110, planning and execution system 120, transportation network 130, archiving system 140, and one or more supply chain entities 150. One or more computers 160 may include any suitable input device 162, such as a keypad, mouse, touch screen, microphone, or other device to input information. Output device 164 may convey information associated with the operation of supply chain network 100, including digital or analog data, visual information, or audio information. One or more computers 160 may include fixed or removable computer-readable storage media, including a non-transitory computer readable medium, magnetic computer disks, flash drives, CD-ROM, in-memory device or other suitable media to receive output from and provide input to supply chain network 100.

One or more computers 160 may include one or more processors 166 and associated memory to execute instructions and manipulate information according to the operation of supply chain network 100 and any of the methods described herein. In addition, or as an alternative, embodiments contemplate executing the instructions on one or more computers 160 that cause one or more computers 160 to perform functions of the methods. An apparatus implementing special purpose logic circuitry, for example, one or more field programmable gate arrays (FPGA) or application-specific integrated circuits (ASIC), may perform functions of the methods described herein. Further examples may also include articles of manufacture including tangible non-transitory computer-readable media that have computer-readable instructions encoded thereon, and the instructions may comprise instructions to perform functions of the methods described herein.

In addition, or as an alternative, supply chain network 100 may comprise a cloud-based computing system, including but not limited to serverless cloud computing, having processing and storage devices at one or more locations, local to, or remote from, layered scheduling system 110, planning and execution system 120, transportation network 130, archiving system 140, and one or more supply chain entities 150. In addition, each of one or more computers 160 may be a workstation, personal computer (PC), network computer, notebook computer, tablet, personal digital assistant (PDA), cell phone, telephone, smartphone, wireless data port, augmented or virtual reality headset, or any other suitable computing device. In an embodiment, one or more users may be associated with layered scheduling system 110 and archiving system 140. These one or more users may include, for example, an “administrator” handling machine learning model training, administration of cloud computing systems, and/or one or more related tasks within supply chain network 100. In the same or another embodiment, one or more users may be associated with planning and execution system 120 and one or more supply chain entities 150.

In one embodiment, layered scheduling system 110 may be coupled with network 170 using communication link 172, which may be any wireline, wireless, or other link suitable to support data communications between layered scheduling system 110 and network 170 during operation of supply chain network 100. Planning and execution system 120 may be coupled with network 170 using communication link 174, which may be any wireline, wireless, or other link suitable to support data communications between planning and execution system 120 and network 170 during operation of supply chain network 100. Transportation network 130 may be coupled with network 170 using communication link 176, which may be any wireline, wireless, or other link suitable to support data communications between transportation network 130 and network 170 during operation of supply chain network 100. Archiving system 140 may be coupled with network 170 using communication link 178, which may be any wireline, wireless, or other link suitable to support data communications between archiving system 140 and network 170 during operation of supply chain network 100. One or more supply chain entities 150 may be coupled with network 170 using communication link 180, which may be any wireline, wireless, or other link suitable to support data communications between one or more supply chain entities 150 and network 170 during operation of supply chain network 100. One or more computers 160 may be coupled with network 170 using communication link 182, which may be any wireline, wireless, or other link suitable to support data communications between one or more computers 160 and network 170 during operation of supply chain network 100. Although communication links 172-182 are shown as generally coupling layered scheduling system 110, planning and execution system 120, transportation network 130, archiving system 140, one or more supply chain entities 150, and one or more computers 160 to network 170, any of layered scheduling system 110, planning and execution system 120, transportation network 130, archiving system 140, one or more supply chain entities 150, and one or more computers 160 may communicate directly with each other, according to particular needs.

In another embodiment, network 170 includes the Internet and any appropriate local area networks (LANs), metropolitan area networks (MANs), or wide area networks (WANs) coupling layered scheduling system 110, planning and execution system 120, transportation network 130, archiving system 140, one or more supply chain entities 150, and one or more computers 160. For example, data may be maintained locally to, or externally of, layered scheduling system 110, planning and execution system 120, transportation network 130, archiving system 140, one or more supply chain entities 150, and one or more computers 160 and made available to one or more associated users of layered scheduling system 110, planning and execution system 120, transportation network 130, archiving system 140, one or more supply chain entities 150, and one or more computers 160 using network 170 or in any other appropriate manner. For example, data may be maintained in a cloud database at one or more locations external to layered scheduling system 110, planning and execution system 120, transportation network 130, archiving system 140, one or more supply chain entities 150, and one or more computers 160 and made available to one or more associated users of layered scheduling system 110, planning and execution system 120, transportation network 130, archiving system 140, one or more supply chain entities 150, and one or more computers 160 using the cloud or in any other appropriate manner. Those skilled in the art will recognize that the complete structure and operation of network 170 and other components within supply chain network 100 are not depicted or described. Embodiments may be employed in conjunction with known communications networks and other components.

FIG. 2 illustrates layered scheduling system 110, archiving system 140, and planning and execution system 120 of FIG. 1 in greater detail, in accordance with an embodiment. Layered scheduling system 110 may comprise server 112 and database 114, as described above. Although layered scheduling system 110 is shown as comprising a single server 112 and a single database 114, embodiments contemplate layered scheduling system 110 comprising any suitable number of servers or databases, serverless computing options, or data stores, internal to, or externally coupled with, layered scheduling system 110, according to particular needs.

Server 112 of layered scheduling system 110 comprises partition module 202, schedule optimizer module 204, and user interface module 206. Although server 112 is shown and described as comprising a single partition module 202, a single schedule optimizer module 204, and a single user interface module 206, embodiments contemplate any suitable number or combination of these located at one or more locations, local to, or remote from, layered scheduling system 110, such as on multiple servers or computers 160 at one or more locations in supply chain network 100. Embodiments of layered scheduling system 110 may utilize serverless computing options to execute the processes of data processing module 202, schedule optimizer module 204, and user interface module 206.

Partition module 202 partitions a scheduling problem, such as a problem to schedule tasks in a production line, into ordered subsets. In embodiments, the scheduling problem may be generated or formulated by planning and execution system 120 and may describe a scheduling scenario for a particular factory or manufacturer, such as a manufacturer of one or more manufacturers 154 of FIG. 1. Partition module 202 may base the partitioning on business requirements of a factory or manufacturer associated with the scheduling problem, such as the relative priority of tasks that are to be performed within the factory or manufacturer, the value of finished goods that are to be produced in the factory or manufacturer, the requirements of use on resources of the factory or manufacturer, or any other criteria that may be used to determine priority of tasks within the factory or manufacturer. In general, partition module 202 may generate the ordered subsets such that more important demand is planned first when the subsets are scheduled.

Schedule optimizer module 204 schedules the ordered subsets of the scheduling problem in sequence according to the relative priority of the subsets. In embodiments, schedule optimizer module 204 may optimize the first (highest priority) subset and then freeze the resulting plan, meaning the highest priority demands contained in the first subset are locked into subsequent plans. Schedule optimizer module 204 may then step through the remaining subsets of the scheduling problem and freeze the schedule after solving each subset to iteratively lock in the demands of each subset. In embodiments, schedule optimizer module 204 may, once all subsets of the scheduling problem are scheduled, run a final pass of the scheduling algorithm to improve global schedule metrics by resolving specific issues that may be present in the final overall schedule when the final subset is scheduled.

User interface module 206 of layered scheduling system 110 generates and displays a user interface (UI), such as, for example, a graphical user interface (GUI), that displays one or more scheduling problems, plans, demand priorities, or problem subsets. According to embodiments, user interface module 206 displays a GUI comprising interactive graphical elements for selecting one or more schedules, plans, problems, and/or data of any kind stored in database 114 of layered scheduling system 110 and displaying the selected data on one or more display devices in response to the selection. According to embodiments, the data from the UI may also be displayed in other UIs from any other systems or modules throughout supply chain network 100, such as, for example, a factory planning module, or any other integration.

Database 114 of layered scheduling system 110 may comprise, according to embodiments, one or more databases, data stores, or other data storage arrangements at one or more locations, local to, or remote from, server 112. In an embodiment, database 114 of layered scheduling system 110 comprises schedule problem data 210, demand priority data 212, problem subsets data 214, and schedule data 216. Although database 114 of layered scheduling system 110 is shown and described as comprising schedule problem data 210, demand priority data 212, problem subsets data 214, and schedule data 216, embodiments contemplate any suitable number or combination of these, located at one or more locations, local to, or remote from, layered scheduling system 110 according to particular needs.

In an embodiment, schedule problem data 210 comprises data associated with a scheduling problem for a factory or manufacturer, such as a manufacturer of one or more manufacturers 154 of FIG. 1, or any other supply chain entity of one or more supply chain entities 150. For example, in other embodiments, layered scheduling system 110 may utilize scheduling data for other supply chain entities such as distribution centers, transportation providers, or logistics providers. Schedule problem data 210 may comprise a set of tasks and available resources of the factory or manufacturer and expected or demanded outputs of the factory or manufacturer within a specific time frame, such as for a day, a week, or any other period of time, according to particular needs. In embodiments, schedule problem data 210 may be generated by planning and execution system 120 using a problem formulation module based on a plan such as a factory plan or other supply chain plan. In embodiments, schedule problem data 210 may include, as relevant to the scheduling problem, a set of tasks that are to be sequenced in one or more sequences, where some sequences are considered more desirable than others, based on a set of metrics, such as time performance, setup cost, resource utilization, and the like. Tasks that are suitable for scheduling may come from an external planning module, such as a factory planning or transportation planning module, or may be generated within a scheduling model. Such tasks may be independent of one another or may have various interdependencies, such as one task supplying material to another task, where supplying tasks must be sequenced earlier in time than the tasks they are supplying. Tasks are typically assigned to resources which act to accomplish these tasks, where alternate resources may require different amounts of time or cost to accomplish the same task, and/or where resources are limited in availability and tasks need to be completed within a certain time period. In general, a scheduling problem refers to the problem of arranging the tasks on the resources which accomplish the tasks so as to maximize the value of an objective function comprising one or more objectives to be achieved in the scheduling process. For example, an objective may comprise minimizing cost of resources, minimizing lateness of the tasks, minimizing set up cost, minimizing unused resource capacity, and the like. In addition, tradeoffs may be defined between conflicting scheduling objectives, such as, for example, a certain amount of lateness may be preferred over adding additional setup cost.

Demand priority data 212 comprises a ranked hierarchy of tasks or demands within the factory or manufacturer to be performed in order from highest priority to lowest priority. For example, tasks to complete certain in-process goods may be considered high priority based on a customer or order associated with the in-process goods. In other examples, a task may be considered high priority because of a sequence of tasks that need to be performed on a work in progress, or any other business requirements of the factory or manufacturer that may require the prioritization of certain tasks within the factory or manufacturer, including for regulatory or reporting purposes.

Problem subsets data 214 comprises the scheduling problem partitioned into subsets ordered by priority. According to embodiments, partition module 202 may generate problem subsets data 214 by partitioning schedule problem data 210. Problem subsets data 214 may be used by schedule optimizer module 204 to solve the subsets of the scheduling problem using a layered scheduling approach, which retains the relative priority of the demands of the scheduling problem.

Schedule data 216 comprises the completed overall schedule generated by schedule optimizer module 204. Schedule data 216 may be implemented within supply chain network 100 to schedule and perform tasks needed to manufacture or transport finished goods, or any other type of scheduling problem required in planning the supply chain. For example, layered scheduling system 110 may transmit schedule data 216 to planning and execution system 120 or any other one or more computers 160 or one or more supply chain entities 150 within supply chain network 100, which may then implement or display the overall schedule. Implementation of the overall schedule may include the operation of one or more pieces of automated machinery (e.g., automated distribution systems 153, automated robotic production machinery 155, automated warehousing systems 157, shelving systems 159, and/or the like), displaying the schedule or sections thereof on display devices within the supply chain environment, or any other implementation steps.

As discussed above, archiving system 140 comprises server 142 and database 144. Although archiving system 140 is shown as comprising a single server 142 and a single database 144, embodiments contemplate any suitable number of servers or databases internal to, or externally coupled with, archiving system 140.

Server 142 of archiving system 140 comprises data retrieval module 220. Although server 142 is shown and described as comprising a single data retrieval module 220, embodiments contemplate any suitable number or combination of data retrieval modules located at one or more locations, local to, or remote from, archiving system 140, such as on multiple servers or computers 160 at one or more locations in supply chain network 100.

In one embodiment, data retrieval module 220 of archiving system 140 receives historical supply chain data 230 from planning and execution system 120 and one or more supply chain entities 150 and stores received historical supply chain data 230 in archiving system 140 database 144. According to one embodiment, data retrieval module 220 of archiving system 140 may prepare historical supply chain data 230 for use as the training data of layered scheduling system 110 by checking historical supply chain data 230 for errors and transforming historical supply chain data 230 to normalize, aggregate, and/or rescale historical supply chain data 230 to allow direct comparison of data received from different planning and execution systems 120, one or more supply chain entities 150, and/or one or more other locations local to, or remote from, archiving system 140. According to embodiments, data retrieval module 220 may receive data from one or more sources external to supply chain network 100, such as, for example, weather data, special events data, social media data, calendar data, and the like and stores the received data as historical supply chain data 230.

Database 144 of archiving system 140 may comprise one or more databases or other data storage arrangements at one or more locations, local to, or remote from, server 142. Database 144 of archiving system 140 comprises, for example, historical supply chain data 230. Although database 144 of archiving system 140 is shown and described as comprising historical supply chain data 230, embodiments contemplate any suitable number or combination of data, located at one or more locations, local to, or remote from, archiving system 140, according to particular needs.

Historical supply chain data 230 comprises historical data received from layered scheduling system 110, planning and execution system 120, transportation network 130, one or more supply chain entities 150, and/or one or more computers 160. Historical supply chain data 230 may comprise, for example, weather data, special events data, social media data, calendar data, and the like. In an embodiment, historical supply chain data 230 may comprise, for example, historic sales patterns, prices, promotions, weather conditions, and other factors influencing future demand of the number of one or more items sold in one or more stores over a time period, such as, for example, one or more days, weeks, months, years, including, for example, a day of the week, a day of the month, a day of the year, week of the month, week of the year, month of the year, special events, paydays, and the like.

As discussed above, planning and execution system 120 comprises server 122 and database 124. Although planning and execution system 120 is shown as comprising a single server 122 and a single database 124, embodiments contemplate any suitable number of servers or databases internal to, or externally coupled with, planning and execution system 120.

Server 122 of planning and execution system 120 comprises planning module 240 and prediction module 242. Although server 122 is shown and described as comprising a single planning module 240 and a single prediction module 242, embodiments contemplate any suitable number or combination of planning modules and prediction modules located at one or more locations, local to, or remote from, planning and execution system 120, such as on multiple servers or computers 160 at one or more locations in supply chain network 100.

Database 124 of planning and execution system 120 may comprise one or more databases or other data storage arrangements at one or more locations, local to, or remote from, server 122. Database 124 of planning and execution system 120 comprises, for example, transaction data 250, supply chain data 252, product data 254, inventory data 256, inventory policies 258, store data 260, customer data 262, demand forecasts 264, supply chain models 266, and prediction models 268. Although database 124 of planning and execution system 120 is shown and described as comprising transaction data 250, supply chain data 252, product data 254, inventory data 256, inventory policies 258, store data 260, customer data 262, demand forecasts 264, supply chain models 266, and prediction models 268, embodiments contemplate any suitable number or combination of data, located at one or more locations, local to, or remote from, planning and execution system 120, according to particular needs.

Planning module 240 of planning and execution system 120 works in connection with prediction module 242 to generate a plan based on one or more predicted retail volumes, classifications, or other predictions. By way of example and not of limitation, planning module 240 may comprise a demand planner that generates a demand forecast for one or more supply chain entities 150. Planning module 240 may generate the demand forecast, at least in part, from predictions and calculated factor values for one or more causal factors received from prediction module 242. By way of a further example, planning module 240 may comprise an assortment planner and/or a segmentation planner that generates product assortments that match causal effects calculated for one or more customers or products by prediction module 242, which may provide for increased customer satisfaction and sales, as well as reduced costs for shipping and stocking products at stores where they are unlikely to sell.

Prediction module 242 of planning and execution system 120 applies samples of transaction data 250, supply chain data 252, product data 254, inventory data 256, store data 260, customer data 262, demand forecasts 264, and other data to prediction models 268 to generate predictions and calculated factor values for one or more causal factors. Prediction module 242 of planning and execution system 120 predicts a volume Y (target) from a set of causal factors X along with causal factors strengths that describe the strength of each causal factor variable contributing to the predicted volume. According to some embodiments, prediction module 242 generates predictions at daily intervals. However, embodiments contemplate longer and shorter prediction phases that may be performed, for example, weekly, twice a week, twice a day, hourly, or the like.

Transaction data 250 of planning and execution system 120 database 124 may comprise recorded sales and returns transactions and related data, including, for example, a transaction identification, time and date stamp, channel identification (such as stores or online touchpoints), product identification, actual cost, selling price, sales volume, customer identification, promotions, and/or the like. In addition, transaction data 250 is represented by any suitable combination of values and dimensions, aggregated or un-aggregated, such as, for example, sales per week, sales per week per location, sales per day, sales per day per season, or the like.

Supply chain data 252 may comprise any data of one or more supply chain entities 150 including, for example, item data, identifiers, metadata (comprising dimensions, hierarchies, levels, members, attributes, cluster information, and member attribute values), fact data (comprising measure values for combinations of members), business constraints, goals, and objectives of one or more supply chain entities 150.

Product data 254 of database 124 may comprise products identified by, for example, a product identifier (such as a Stock Keeping Unit (SKU), Universal Product Code (UPC), or the like) and one or more attributes and attribute types associated with the product ID. Product data 254 may comprise data about one or more products organized and sortable by, for example, product attributes, attribute values, product identification, sales volume, demand forecast, or any stored category or dimension. Attributes of one or more products may be, for example, any categorical characteristic or quality of a product, and an attribute value may be a specific value or identity for the one or more products according to the categorical characteristic or quality, including, for example, physical parameters (such as, for example, size, weight, dimensions, color, and the like).

Inventory data 256 of database 124 may comprise any data relating to current or projected inventory quantities or states, order rules, or the like. For example, inventory data 256 may comprise the current level of inventory for each item at one or more stocking points across supply chain network 100. In addition, inventory data 256 may comprise order rules that describe one or more rules or limits on setting an inventory policy, including, but not limited to, a minimum order volume, a maximum order volume, a discount, and a step-size order volume, and batch quantity rules. According to some embodiments, planning and execution system 120 accesses and stores inventory data 256 in database 124, which may be used by planning and execution system 120 to place orders, set inventory levels at one or more stocking points, initiate manufacturing of one or more components, or the like in response to, and based at least in part on, a forecasted demand of planning and execution system 120.

Inventory policies 258 of database 124 may comprise any suitable inventory policy describing the reorder point and target quantity, or other inventory policy parameters that set rules for layered scheduling system 110 and/or planning and execution system 120 to manage and reorder inventory. Inventory policies 258 may be based on target service level, demand, cost, fill rate, or the like. According to embodiments, inventory policies 258 comprise target service levels that ensure that a service level of one or more supply chain entities 150 is met with a set probability. For example, one or more supply chain entities 150 may set a service level at 95%, meaning one or more supply chain entities 150 sets the desired inventory stock level at a level that meets demand 95% of the time. Although a particular service level target and percentage is described, embodiments contemplate any service target or level, such as, for example, a service level of approximately 99% through 90%, a 75% service level, or any suitable service level, according to particular needs. Other types of service levels associated with inventory quantity or order quantity may comprise, but are not limited to, a maximum expected backlog and a fulfillment level. Once the service level is set, layered scheduling system 110 and/or planning and execution system 120 may determine a replenishment order according to one or more replenishment rules, which, among other things, indicates to one or more supply chain entities 150 to determine or receive inventory to replace the depleted inventory. By way of example only and not by way of limitation, an inventory policy for non-perishable goods with linear holding and shorting costs comprises a min./max. (s,S) inventory policy. Other inventory policies 258 may be used for perishable goods, such as fruit, vegetables, dairy, fresh meat, as well as electronics, fashion, and similar items for which demand drops significantly after a next generation of electronic devices or a new season of fashion is released.

Store data 260 may comprise data describing the stores of one or more retailers 158 and related store information. Store data 260 may comprise, for example, a store ID, store description, store location details, store location climate, store type, store opening date, lifestyle, store area (expressed in, for example, square feet, square meters, or other suitable measurement), latitude, longitude, and other similar data.

Customer data 262 may comprise customer identity information, including, for example, customer relationship management data, loyalty programs, and mappings between product purchases and one or more customers so that a customer associated with a transaction may be identified. Customer data 262 may comprise data relating customer purchases to one or more products, geographical regions, store locations, or other types of dimensions. In an embodiment, customer data 262 may also comprise customer profile information including demographic information and preferences.

Demand forecasts 264 of database 124 may indicate future expected demand based on, for example, any data relating to past sales, past demand, purchase data, promotions, events, or the like of one or more supply chain entities 150. Demand forecasts 264 may cover a time interval such as, for example, by the minute, hour, daily, weekly, monthly, quarterly, yearly, or any other suitable time interval, including substantially in real time. Demand may be modeled as a negative binomial or Poisson-Gamma distribution. According to other embodiments, the model also takes into account shelf-life of perishable goods (which may range from days (e.g., fresh fish or meat) to weeks (e.g., butter) or even months, before any unsold items have to be written off as waste) as well as influences from promotions, price changes, rebates, coupons, and even cannibalization effects within an assortment range. In addition, customer behavior is not uniform but varies throughout the week and is influenced by seasonal effects and the local weather, as well as many other contributing factors. Accordingly, even when demand generally follows a Poisson-Gamma model, the exact values of the parameters of the model may be specific to a single product to be sold on a specific day in a specific location or sales channel and may depend on a wide range of frequently changing influencing causal factors. As an example only and not by way of limitation, an exemplary supermarket may stock twenty thousand items at one thousand locations. When each location of this exemplary supermarket is open every day of the year, planning and execution system 120 comprising a demand planner needs to calculate approximately 2×10 \hat{ }10 demand forecasts 264 each day to derive the optimal order volume for the next delivery cycle (e.g., three days).

Supply chain models 266 of database 124 comprise characteristics of a supply chain setup to deliver the customer expectations of a particular customer business model. These characteristics may comprise differentiating factors, such as, for example, MTO (Make-to-Order), ETO (Engineer-to-Order), or MTS (Make-to-Stock). However, supply chain models 266 may also comprise characteristics that specify the supply chain structure in even more detail, including, for example, specifying the type of collaboration with the customer (e.g., Vendor-Managed Inventory (VMI)), from where products may be sourced, and how products may be allocated, shipped, or paid for, by particular customers. Each of these characteristics may lead to a different supply chain model. Prediction models 268 comprise one or more of the trained models used by planning and execution system 120 for predicting, among other variables, pricing, targeting, or retail volume, such as, for example, a forecasted demand volume for one or more products at one or more stores of one or more retailers 158 based on the prices of the one or more products.

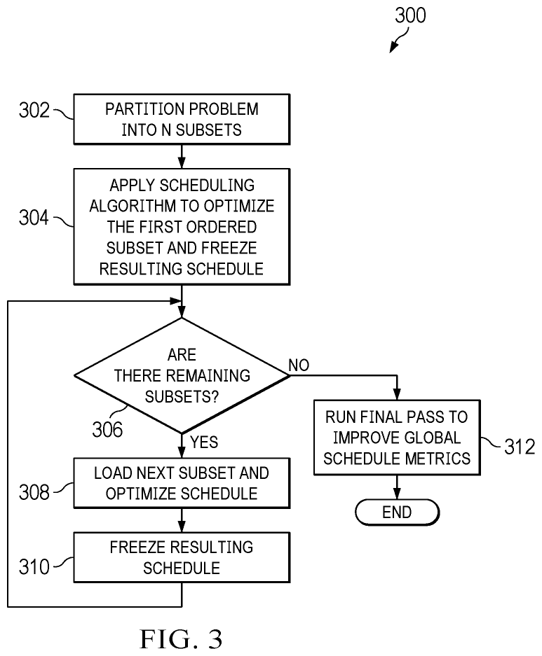

FIG. 3 illustrates method 300 for layered scheduling, in accordance with an embodiment. Method 300 may be performed by a layered scheduling system, such as layered scheduling system 110 of FIG. 1. Method 300 proceeds by one or more activities, which although described in a particular order, may be performed in one or more permutations, according to particular needs.

At activity 302, partition module 202 of layered scheduling system 110 partitions a scheduling problem, such as a scheduling problem for a production line of a factory as described in further detail above, into n ordered subsets. In embodiments, partition module 202 may partition the scheduling problem based on a prioritization scheme determined by business requirements or any other criteria, according to particular needs. Partition module 202 may derive the partitions from the nature or goal of the scheduling problem itself and may partition demands to give greater priority to more important demands. The n ordered subsets are defined such that subset i−1 is higher priority than subset i, for all i>1.

At activity 304, schedule optimizer module 204 of layered scheduling system 110 applies a scheduling algorithm, or schedule optimizer, to optimize the first subset of the ordered subsets, and freezes the resulting schedule. In embodiments, this freezing may enable the schedule supplying demands prioritized in the first subset to be locked place so that priority is preserved in the schedule for subsequent subset solving.

At activity 306, scheduler optimizer module 204 determines whether there are any remaining subsets that have not been scheduled. When schedule optimizer module 204 determines that there are remaining subsets that have not been scheduled, at activity 308, schedule optimizer module 204 loads the next subset (with the next-highest priority) and optimizes the schedule again without disturbing the schedule for previously scheduled subsets. Then, at activity 310, schedule optimizer module 204 freezes the resulting schedule.

When, at activity 306, scheduling optimizer module 204 determines that there are no remaining subsets to solve, then, at activity 312, scheduling optimizer module 204 may run a final pass of the same or a different scheduling algorithm to improve global schedule metrics. In embodiments, the final pass algorithm may resolve specific issues present in the overall solution to the scheduling problem after the final subset has been scheduled.

To further illustrate the operation of method 300, the following example based on simulated data is provided. In the following example, a manufacturer has a set of 1,000 demand orders within a complex production scheduling problem. In this example, partition module 202 of layered scheduling system 110 breaks the 1,000 demand orders into ten subsets of one hundred orders each at activity 302. Partition module 202 orders the ten subsets by due date, where the demands with the one hundred earliest due dates are in the first subset, and the demand with the one hundred latest due dates are in the final subset.

Continuing the example above, schedule optimizer module 204 of layered scheduling system 110 assigns capacity and defines an optimal sequence for the first subset, and locks in this first optimized schedule at activity 304. At activity 306, schedule optimizer module 204 determines that there are remaining unscheduled subsets (subsets two through ten). Then, schedule optimizer module 204 adds the second subset of demands and optimizes the second schedule at activity 308 and locks the second schedule at activity 310. Schedule optimizer module 204 repeats activities 306-310 for the remaining subsets (subsets three through ten) until the schedule for subset ten is optimized. After scheduling subset ten, schedule optimizer module 204 unlocks the entire schedule and, when necessary, runs a final pass of the scheduling algorithm on the full production schedule at activity 312 to resolve any remaining resource issues and attempt to further improve production schedule metrics for the schedule.

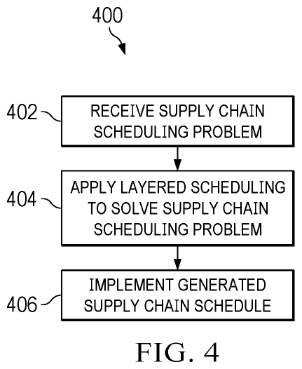

FIG. 4 illustrates method 400 for solving a supply chain scheduling problem, in accordance with an embodiment. Method 400 may be performed by a layered scheduling system, such as layered scheduling system 110 of FIG. 1. Method 400 proceeds by one or more activities, which although described in a particular order, may be performed in one or more permutations, according to particular needs.

At activity 402, layered scheduling system 110 receives a supply chain scheduling problem that includes a set of one or more tasks to be performed on a limited capacity of resources of one or more resources within a supply chain, such as a manufacturer of one or more manufacturers 154 of FIG. 1, or any other one or more supply chain entities 150 of FIG. 1. The supply chain scheduling problem may include one or more demand priorities for the demands, indicating the order to solve the demands. For example, certain high-priority tasks may be assigned in the manufacturer due to time-sensitive or otherwise important production needs. According to embodiments, demand priority may also be based on a sequence of tasks that need to be performed on a particular work in process within the manufacturer.

At activity 404, layered scheduling system 110 applies layered scheduling to solve the supply chain scheduling problem generated at activity 402. For example, layered scheduling system 110 may use method 300 described with respect to FIG. 3 to apply layered scheduling. Use of layered scheduling preserves the demand priorities within the supply chain by partitioning the supply chain scheduling problem into ordered subsets ordered by priority.

At activity 406, layered scheduling system 110 implements the generated supply chain schedule within supply chain network 100. For example, the supply chain schedule may include positioning of tasks within a manufacturer in a way that preserves the demand priorities of the supply chain scheduling problem. Layered scheduling system 110 may display the supply chain schedule on one or more output devices 164 of one or more computers 160 within supply chain network 100 or one or more other supply chain entities 150. In embodiments, layered scheduling system 110 may implement the generated supply chain schedule using automated robotic production machinery 155 of one or more manufacturers 154 as described above with respect to FIG. 1.

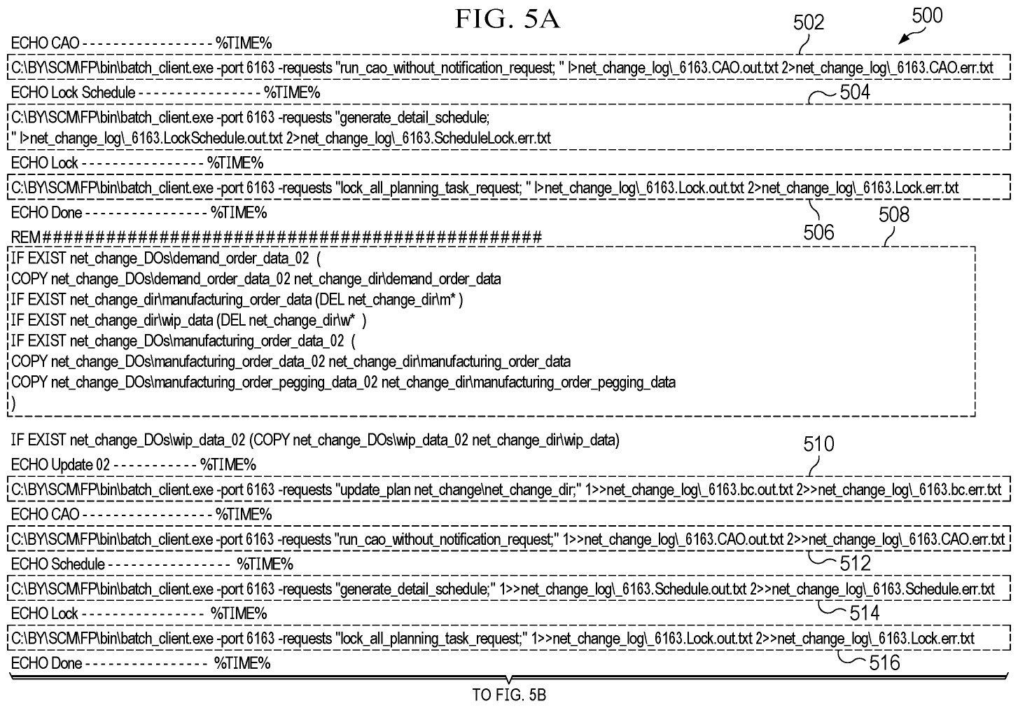

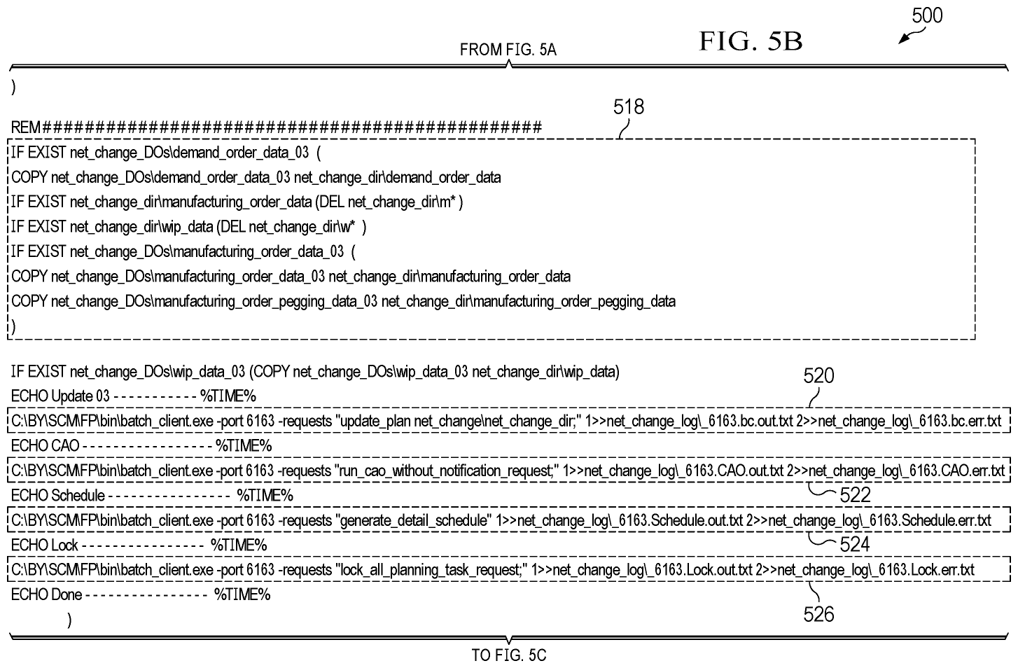

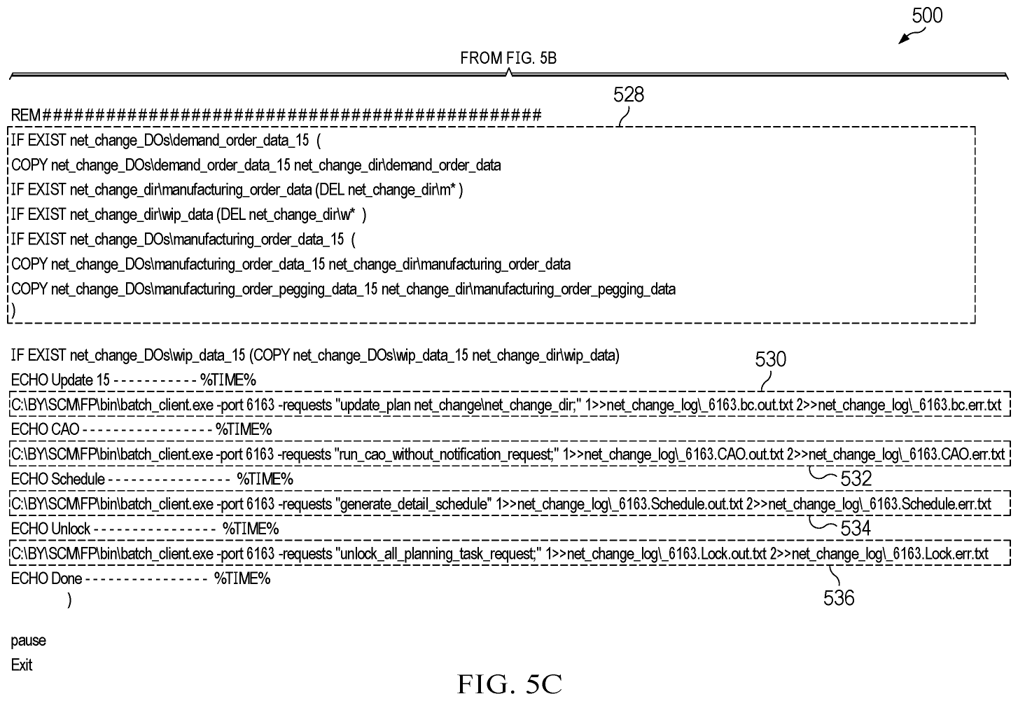

FIGS. 5A-5C illustrate method 500 of performing layered scheduling in a factory scheduling setting, in accordance with an embodiment. Method 500 may be performed by a layered scheduling system, such as layered scheduling system 110 of FIG. 1. Method 500 proceeds by one or more activities, which although described in a particular order, may be performed in one or more permutations, according to particular needs. At activity 502, layered scheduling system 110 executes a Constraint Anchored Optimization (CAO™) capacity balancing algorithm on demand set “Set.01” which, in this example, has already been loaded into a scheduling model. At activity 504, layered scheduling system 110 generates a schedule of all of the tasks in the model after capacity balancing is complete and, at activity 506, locks the scheduled tasks after capacity balancing is complete.

At activity 508, layered scheduling system 110 checks to see whether data files are present for demand set “Set.02” and copies relevant files into a folder so that demand set Set.02 data may be uploaded into the scheduling model. At activity 510, layered scheduling system 110 uploads the data for demand set Set.02 into the scheduling model and, at activity 512, runs the CAO™ to balance the current plan in the scheduling model, where the scheduled tasks of manufacturing orders supplying demand set Set.01 are scheduled and locked and the scheduled tasks of manufacturing orders supplying demands in demand set Set.02 are unlocked so that the scheduled tasks of manufacturing orders supply demands in demand set Set.02 may be modified by the CAO™.

At activity 514, layered scheduling system 110 schedules all of the tasks in the scheduling model (specifically those tasks supplying demands in demand set Set.02, which are not yet scheduled) after capacity balancing is complete. After scheduling is complete, at activity 516, layered scheduling system 110 locks the scheduled tasks (specifically those supplying demands in demand set Set.02) that are not already locked.

Layered scheduling system 110 repeats the process described by activities 508-516 for demand set “Set.03” at activities 518-526. That is, layered scheduling system 110 checks whether data files are present for demand set Set.03 and copies relevant files into a folder so that demand set Set.03 data may be uploaded into the scheduling model at activity 518, uploads the data for demand set Set.03 into the scheduling model at activity 520, runs the CAO™ to balance the current schedule in the scheduling model at activity 522, schedules all of the tasks in the scheduling model that are not yet scheduled after capacity balancing is complete at activity 524, and locks all of the scheduled tasks after scheduling is complete at activity 526. This pattern repeats for demand set “Set.04” through demand set “Set. 14,” which differ only in the demand sets being processed, and are thus excluded from FIGS. 5A-5C to simplify the illustration.

Layered scheduling system 110 checks whether data files are present for demand set “Set. 15” and copies relevant files into a folder so that demand set Set. 15 data may be uploaded into the scheduling model at activity 528, uploads the data for demand set Set. 15 into the scheduling model at activity 530, runs the CAO™ to balance the current schedule in the scheduling model at activity 532, and schedules all of the tasks in the scheduling model that are not yet scheduled after capacity balancing is complete at activity 534, repeating the workflow for demand set Set. 15, the last demand set in this example. However, instead of locking the scheduled tasks for all scheduled tasks after capacity balancing is complete, such as in activity 516 and activity 526, at activity 536, layered scheduling system 110 unlocks all of the tasks in the plan to enable a final optimization pass of the entire schedule. Method 500 may conclude by pausing the screen to display the status to the user until the user presses a key on the keyboard, at which point method 500 terminates and closes the workflow window. Method 500, as shown, further includes various activities to provide time stamps to display algorithm progress and timing during execution and/or provide remarks or empty lines to make the code easier for humans to read.

Reference in the foregoing specification to “one embodiment”, “an embodiment”, or “some embodiments” means that a particular correlated factor, structure, or characteristic described in connection with the embodiment is included in at least one embodiment of the invention. The appearances of the phrase “in one embodiment” in various places in the specification are not necessarily all referring to the same embodiment.

While the exemplary embodiments have been shown and described, it will be understood that various changes and modifications to the foregoing embodiments may become apparent to those skilled in the art without departing from the spirit and scope of the present invention.

What is claimed is:

1. A system, comprising:
a computer, comprising a processor and a memory, the computer configured to:
partition a scheduling problem into ordered subsets based on a prioritization scheme;
apply a scheduling algorithm to optimize a first subset of the ordered subsets and freeze a corresponding schedule;
determine whether there are any remaining subsets that have not been optimized;
in response to the determining that there are any remaining subsets that have not been optimized, load a next subset ordered according to the prioritization scheme;
optimize the loaded subset without disturbing the frozen schedule; and
in response to determining that there are no remaining subsets to optimize, run a final pass of the scheduling algorithm to improve one or more global schedule metrics.

2. The system of claim 1, wherein the prioritization scheme is based on a relative priority of one or more tasks to be performed, a value of finished goods that are to be produced or one or more requirements regarding a use of resources.

3. The system of claim 1, wherein each subset of the ordered subsets corresponds to a demand.

4. The system of claim 1, wherein the one or more global schedule metrics comprise one or more of: a time performance, a setup cost and a resource utilization.

5. The system of claim 1, wherein the prioritization scheme is based on a customer or an order associated with one or more in-process goods.

6. The system of claim 1, wherein the scheduling algorithm further comprises one or more objective functions, the one or more objective functions comprising one or more of:
minimizing a cost of one or more resources, minimizing a lateness of one or more tasks, minimizing one or more setup costs and minimizing unused resource capacity.

7. The system of claim 6, wherein the computer is further configured to:
define a tradeoff between at least two of the one or more objective functions.

8. A computer-implemented method, comprising:
partitioning, by a computer comprising a processor and a memory, a scheduling problem into ordered subsets based on a prioritization scheme;
applying, by the computer, a scheduling algorithm to optimize a first subset of the ordered subsets and freeze a corresponding schedule;
determining, by the computer, whether there are any remaining subsets that have not been optimized;
in response to the determining that there are any remaining subsets that have not been optimized, loading, by the computer, a next subset ordered according to the prioritization scheme;
optimizing, by the computer, the loaded subset without disturbing the frozen schedule; and
in response to determining that there are no remaining subsets to optimize, running, by the computer, a final pass of the scheduling algorithm to improve one or more global schedule metrics.

9. The computer-implemented method of claim 8, wherein the prioritization scheme is based on a relative priority of one or more tasks to be performed, a value of finished goods that are to be produced or one or more requirements regarding a use of resources.

10. The computer-implemented method of claim 8, wherein each subset of the ordered subsets corresponds to a demand.

11. The computer-implemented method of claim 8, wherein the one or more global schedule metrics comprise one or more of: a time performance, a setup cost and a resource utilization.

12. The computer-implemented method of claim 8, wherein the prioritization scheme is based on a customer or an order associated with one or more in-process goods.

13. The computer-implemented method of claim 8, wherein the scheduling algorithm further comprises one or more objective functions, the one or more objective functions comprising one or more of:
minimizing a cost of one or more resources, minimizing a lateness of one or more tasks, minimizing one or more setup costs and minimizing unused resource capacity.

14. The computer-implemented method of claim 13, further comprising:
defining, by the computer, a tradeoff between at least two of the one or more objective functions.

15. A non-transitory computer-readable medium embodied with software, the software when executed is configured to:
partition, by a computer comprising a processor and a memory, a scheduling problem into ordered subsets based on a prioritization scheme;
apply a scheduling algorithm to optimize a first subset of the ordered subsets and freeze a corresponding schedule;
determine whether there are any remaining subsets that have not been optimized;
in response to the determining that there are any remaining subsets that have not been optimized, load a next subset ordered according to the prioritization scheme;
optimize the loaded subset without disturbing the frozen schedule; and
in response to determining that there are no remaining subsets to optimize, run a final pass of the scheduling algorithm to improve one or more global schedule metrics.

16. The non-transitory computer-readable medium of claim 15, wherein the prioritization scheme is based on a relative priority of one or more tasks to be performed, a value of finished goods that are to be produced or one or more requirements regarding a use of resources.

17. The non-transitory computer-readable medium of claim 15, wherein each subset of the ordered subsets corresponds to a demand.

18. The non-transitory computer-readable medium of claim 15, wherein the one or more global schedule metrics comprise one or more of: a time performance, a setup cost and a resource utilization.

19. The non-transitory computer-readable medium of claim 15, wherein the prioritization scheme is based on a customer or an order associated with one or more in-process goods.

20. The non-transitory computer-readable medium of claim 15, wherein the scheduling algorithm further comprises one or more objective functions, the one or more objective functions comprising one or more of:
minimizing a cost of one or more resources, minimizing a lateness of one or more tasks, minimizing one or more setup costs and minimizing unused resource capacity.
